(19) United States
(12) Patent Application Publication
(10) Pub. No.: US 2012/0192713 A1
(43) Pub. Date: Aug. 2, 2012

(54) Electrostatic Precipitator Charging Enhancement

(76) Inventor: Bruce Edward Scherer, Toledo, OH (US)

(21) Appl. No.: 13/017,563

(22) Filed: Jan. 31, 2011

(51) Int. Cl. B03C 3/47

(52) U.S. Cl. 95/60; 96/52

(57) ABSTRACT

An electrostatic precipitator collector plate assembly including at least one electrically conductive sheet adapted to be electrically grounded; a rib or baffle in physical and electrical contact with the at least one conductive sheet; and a hollow structure physically associated with the rib or baffle adapted to contain a cooling liquid.

This disclosure relates to electrostatic precipitators and, more specifically, to apparatus and methods of reducing particulate emissions from effluent or waste gas streams.

Conventional dry electrostatic precipitators (hereinafter “ESPs”) operate by charging particles and collecting the charged particles in the precipitator. The majority of the particulate matter entering with the gas stream is removed by the ESP. The incoming particles are electrically charged by discharge electrodes, which are energized by high voltage direct current (hereinafter “DC”) sources, positioned in close proximity to electrically grounded structures. In utility and most industrial applications, sufficiently high negative DC voltage is placed upon the discharge electrodes to cause the generation of a visible corona. The ions formed by the corona charge the ash particles, which are attracted to collector plates under the influence of an electric field established between the discharge and collecting electrodes. The collected particulate matter is mechanically removed from the grounded collector plates and allowed to fall into hoppers, from which it is periodically removed.

Particle deposits on the collection surfaces of a conventional ESP possess at least a small degree of electrical conductivity in order to conduct the ionic currents from the corona discharge to ground. An acceptable resistivity as shown both by theory and experience is between 1×10⁹ ohm-cm and 5×10¹⁰ ohm-cm. Ash layers having resistivities greater than the value of 10¹¹ ohm-cm are referred to as high resistivity particles.

In precipitator operation, high particle resistivity is usually exhibited by disturbed electrical conditions in the form of excessive sparking at moderately lowered voltages or by excessive current at greatly lowered voltages, the latter known as “back corona”. These effects cause loss of ESP efficiency, the loss in performance increasing with resistivity. When resistivity exceeds about 10¹¹ ohm-cm, it becomes very difficult to achieve reasonable efficiencies with precipitators of conventional design.

Back corona is the descriptive term for the local discharge from the grounded, normally passive collecting electrode in a corona-discharge system, when the electrode is covered with highly resistive particulate or dust. Under suitable conditions of corona voltage and current, the layer breaks down locally and a small hole or crater is formed from which a visible back corona discharge occurs. Such discharges reduce precipitator collection efficiency by producing positive ions, which decrease particle charging.

Fly ash collection comprises the primary function of a precipitator, with the collection efficiency increasing with precipitator size in terms of gas treated. Fly ash is a generic term used to designate the particulate matter carried in suspension by the effluent or waste gases from furnaces burning fossil fuels, such as pulverized coal. The character and properties of the ash, including resistivity, vary widely with such factors as the sulfur in the coal burned, design and operation of the furnace, and the quality of the burner combustion in the firebox. Not only may the ash differ greatly from plant to plant, but may also vary from day to day in a given plant.

Major constituents of most fly ashes are silica, alumina, and iron oxide. These are present primarily in the fully oxidized state. Carbon may also be a major constituent of some fly ashes, in the case of coal ash, ranging from a fraction of a percent for good combustion up to 10% to 20% for very poor combustion. A carbon content of about 10% or greater may provide some marginal lowering of fly ash resistivity. Coal sulfur content is an important ash resistivity modifying constituent, since it naturally forms sulfur trioxide (SO₃) in the boiler.

Present cold side ESPs rely on flue gas conditioning, either through naturally formed sulfur trioxide, or by injection of additional sulfur trioxide, to reduce ash resistivity to allow reasonable collection efficiencies. Sulfur trioxide addition is an expensive process that, in addition, interferes with mercury capture by activated carbon injection, and can increase SO₃ emissions. (Flue gas conditioning for hot side ESPs generally relies on sodium.)

Previously, to improve the operation of ESPs with high resistivity particulate matter, the installation and use of prechargers has been proposed. These prechargers operate by placing the pre-charger section at the gas inlet of the ESP to charge the particles prior to their introduction into the ESP, and subsequent collection. This configuration requires an expensive separate power supply, rapping system and hopper, and has been shown, in previous research to significantly enhance collection efficiency of high resistivity dust.

Conventional ESPs may comprise multiple, successive charging/collecting precipitator fields, such that subsequent precipitator fields can charge and collect remaining particulates or agglomerates formed by and escaping from previous precipitator fields.

A low cost apparatus and method are needed that provide high current flow in a charging zone and low current flow in a collecting zone of a precipitator field in order to collect high resistivity ash efficiently.

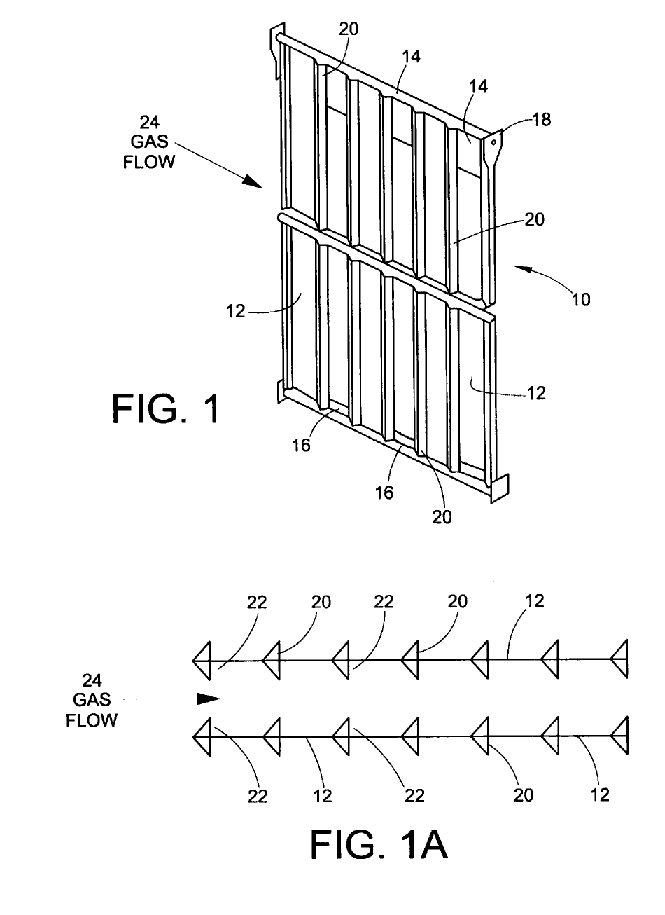

FIG. 1 is a schematic, elevational view of a conventional ESP collector plate.

FIG. 1A is a schematic, top plan view of a conventional ESP collector plate pair.

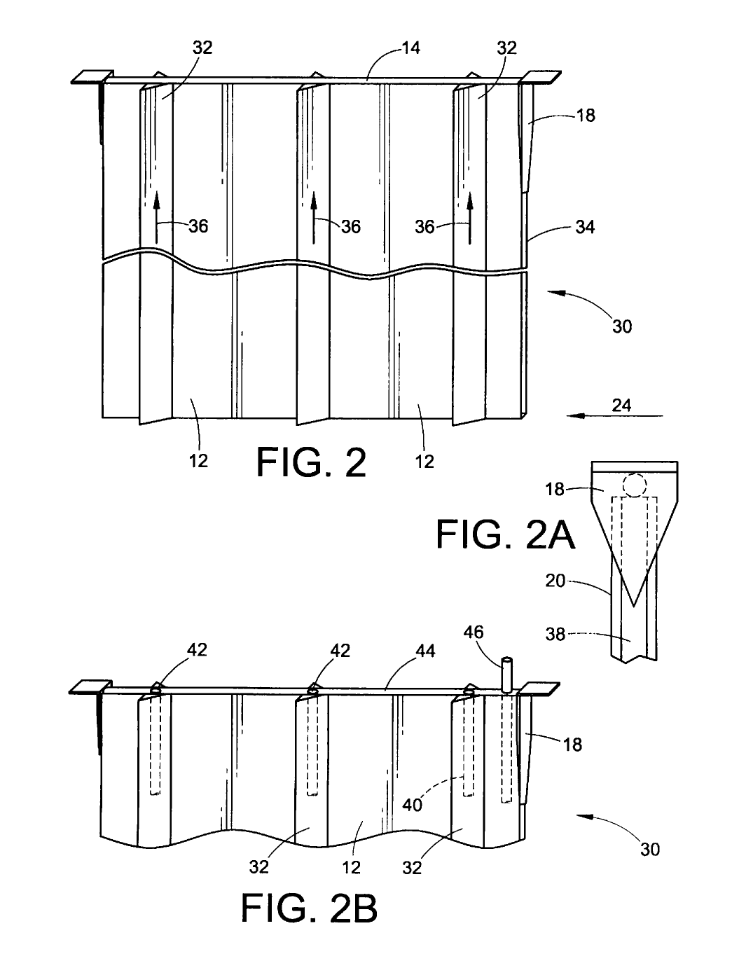

FIG. 2 is a schematic, elevational cutaway view of one embodiment of a subject ESP collector plate having stiffener rib/cooling structures.

FIG. 2A is a schematic, side elevational cutaway view of one embodiment of a subject ESP collector plate having stiffener rib/cooling structures.

FIG. 2B is a schematic, elevational cutaway view of one embodiment of a subject ESP collector plate having stiffener rib/cooling structures and associated cooling fluid conduits.

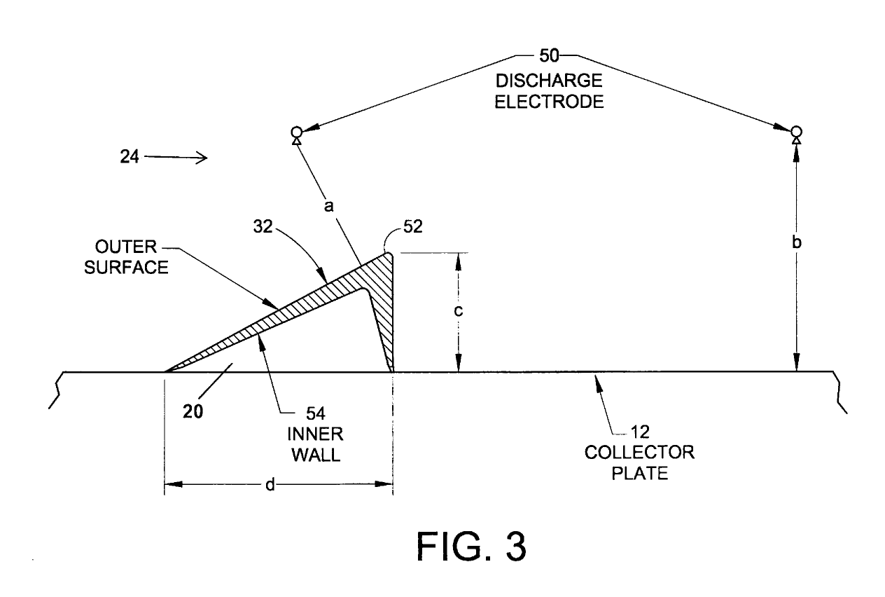

FIG. 3 is a schematic cross-sectional partial view of one embodiment of an ESP collector plate with a protruding rib or baffle to increase turbulence in gas flow and to stiffen the plate, in spaced relation to discharge electrodes.

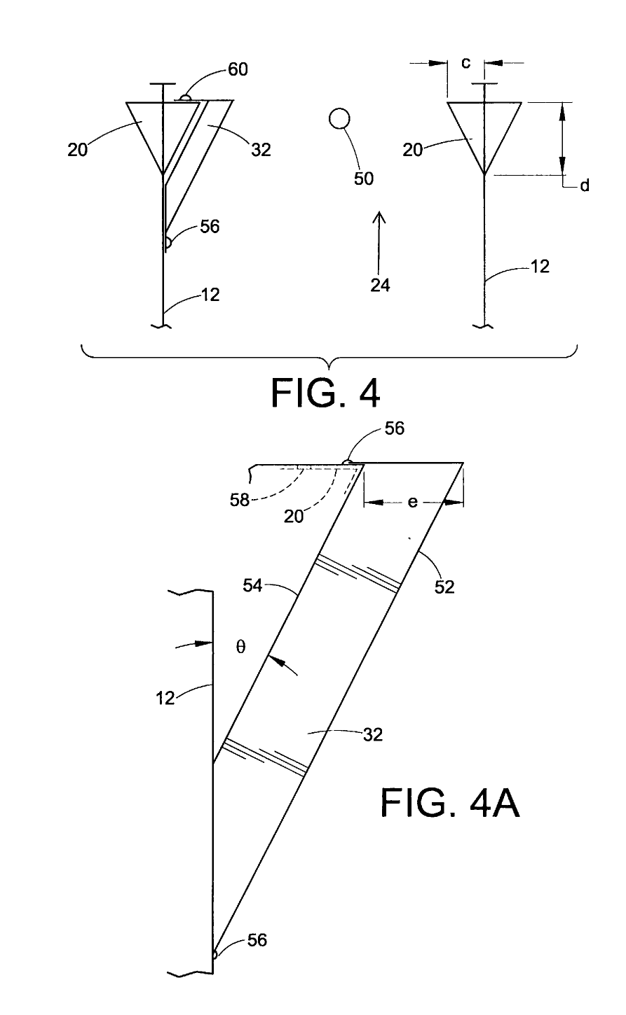

FIG. 4 is a schematic top plan view of one embodiment of a section of an ESP corona discharge system including a pair of ESP collector plates having a leading edge stiffening rib/baffle, one of which has a cooling structure installed, and an associated discharge electrode between the collector plates.

FIG. 4A is a schematic top plan view of one embodiment of a partial section of a collector plate and stiffening rib/baffle which has a cooling structure installed.

The present apparatus and method provide increased charging current density and enhanced charging current density uniformity in the collecting field of a dry electrostatic precipitator (ESP) in order to increase the capture efficiency when collecting high resistivity particulate matter, such as fly ash.

The present apparatus and method overcome back corona, the electrical phenomenon that normally limits power input and reduces capture efficiency when collecting high-resistivity particulate matter, and they do so more cost effectively than previous technology.

Collection efficiency in an ESP is directly proportional to the electrical charge impressed on the particulate flowing through the collecting fields. ESP collecting fields typically comprise rows of large, parallel collector plates having small discharge electrodes placed between them to produce both a particle charging current and an electrical field that drives the charged particles to the collector plates. For a given ESP, this electrical charge is directly proportional to the charging current density between the discharge electrodes and the collector plates. As discussed above, for efficient particulate or fly ash collection, the resistivity of the collected particulate or ash layer on the collector plate must be sufficiently low to pass this charging current through to the grounded metal plate. High resistivity particulate or fly ash may result in a reverse current flow within the particulate or ash layer (back corona) at normal operating ESP current densities, which greatly reduces the particulate matter collection efficiency and increases ESP power consumption.

The present apparatus and method provide a lower cost means to separate the charging and the collecting electric field and resulting currents, but they do so without requiring a separate pre-charging structure. The present apparatus and method apply the understanding that ash resistivity decreases sharply with reduced ash temperature, that charging occurs only between a discharge electrode and a nearby grounded electrode, that this grounded electrode will inevitably collect charged particulate, such as charged fly ash whether or not that is its purpose or design, and that the resistivity of the collected particulate or ash on this surface must be kept low to allow high current densities without experiencing back corona.

An electrostatic precipitator collector plate assembly is provided comprising at least one electrically conductive sheet adapted to be electrically grounded; a rib or baffle in physical and electrical contact with the at least one conductive sheet; and a hollow structure physically associated with the rib or baffle adapted to contain a cooling liquid. The hollow structure may comprise an electrically conductive outer wall. The hollow structure may be in fluid communication with a cooling liquid supply conduit and a cooling liquid outlet conduit. At least one of the cooling liquid supply conduit or the cooling liquid outlet conduit may comprise a stiffener for the at least one conductive sheet.

In certain embodiments a plurality of ribs or baffles are in physical and electrical contact with the at least one conductive sheet, positioned transverse to gas flow within the electrostatic precipitator.

An electrostatic precipitator corona discharge system is also provided comprising:

a) a collector plate assembly comprising at least one electrically conductive sheet adapted to be electrically grounded; a plurality of ribs or baffles in physical and electrical contact with the at least one conductive sheet, positioned transverse to gas flow within the electrostatic precipitator; a hollow structure physically associated with at least one of the ribs or baffles, adapted to contain a cooling liquid, wherein the hollow structure comprises an electrically conductive outer wall; and,

b) a discharge electrode in proximity to the at least one of the ribs or baffles having the associated hollow structure, capable of generating a current density of at least about 50 nA/cm² in the gas flow pass between the discharge electrode and the collector plate assembly. The discharge electrode may be at least one of a conductive wire or a shaped electrode.

The hollow structure may be in fluid communication with a cooling liquid supply conduit and a cooling liquid outlet conduit. The coolant liquid supply conduit may be in fluid communication with each hollow structure on the collector plate assembly. At least one of the cooling liquid supply conduit or the cooling liquid outlet conduit may comprise a stiffener for the at least one conductive sheet.

A method of removing particulate including high resistivity particles from a gas stream is provided comprising providing the corona discharge system described above; flowing the gas stream containing the particulate between a plurality of collector plates; providing a cooling liquid to the hollow structures; generating a corona discharge in the gas flow between the discharge electrode and the collector plate at a current density of at least about 50 nA/cm²; and, collecting the particulate charged by the corona discharge on the collector plate. The method may further include flowing the cooling liquid through the hollow structures from a cooling liquid supply conduit to a cooling liquid outlet conduit.

Pre-chargers, located upstream of ESP collecting fields have three expensive requirements:

1. Space for the physical equipment installation.
2. Separate higher voltage power supplies to drive the necessary current.
3. Separate rapping systems to maintain cleanliness and associated ash hoppers.
These three requirements constitute a physical and financial barrier to the adoption of pre-charger technology for enhancing the efficiency of existing ESPs in collecting high resistivity particulate matter.

The subject apparatus and method integrate the pre-charger function into the existing plate structure of an ESP's collecting field, which:

1. Eliminates the need for an additional physical space for its installation.
2. Utilizes the existing power supply.
3. Uses the existing rapping system and hoppers for maintaining cleanliness.
This greatly reduces the cost of the installation and the complexity of the installed equipment.

In ESPs, the collector electrode is desirably “non-emitting” with regard to corona emission. In certain embodiments, this is achieved by having a flat plate or large radius of curvature in comparison to the discharge elements or electrodes. With horizontal flow units having collector dimensions of up to 3 m×15 m, the collectors usually comprise a number of roll formed channels, typically fabricated from 1.6 mm thick material, mounted between heavy upper and lower “stiffener” members to attain the desired degree of straightness and stiffness.

As shown in FIG. 1, a typical collector plate construction may include sheet steel roll-formed panel plates 12 that may be shop welded together into assemblies 10. The collector plate 12 structural integrity may be fortified by heavy gauge rolled top stiffeners 14 and bottom stiffeners 16. The top stiffener 14 serves both to support the plate 12, and to provide a reliable connection to a top end plate. The top and bottom stiffeners provide straightness from leading to trailing edges of the plate 12. In certain embodiments, the stiffeners 14, 16 make the plate 12 more dynamically responsive to rapping, to aid in collected particulate removal. The collecting plate assembly 10 may have a mounting pad 18, which also introduces the rapping energy into the collecting surface.

The collecting plate assembly 10 of FIGS. 1 and 1A also incorporates the OPZEL™ optimum precipitation zone electrode design of Hamon Research-Cottrell, Somerville, N.J., which provides quiescent zones 22 in the gas flow 24 downstream of the vertical stiffener ribs or baffles 20 to aid in particulate collection and to reduce particulate re-entrainment. Electrical and gas flow quiescence functions are provided by vertical stiffener ribs or baffles 20, as well as vertical straightness.

In accordance with the subject apparatus and method, the stiffener ribs 20 of the collecting electrode plates 12 may be converted into cooled tubes, thereby avoiding a separate cooled pipe structure along with the space for it. Also avoided are separate ash hoppers, electrical charging systems, and electrode cleaning (rapping) systems, as are utilized with typical pre-charger units.

The subject collector plate assembly 30, as shown in FIGS. 2, 2A and 2B, may contain an upper stiffener 14 for plates 12, but also contains a cooling structure 32 for at least one vertical rib or baffle, positioned typically at least at the leading edge 34 of the collector plate assembly 30 with respect to the gas flow 24, optionally adjacent to the attachment plate 18 and plate flange 38. In certain embodiments, a cooling flow 36 of water may be provided internally to the cooling structure 32, such as in a cooling channel 40, shown in more detail in FIGS. 4 and 4A. Internal fluid connections 42 may permit the flow of water 36 in the cooling channel 40 to pass into a tube or pipe 44, optionally serving as an upper stiffener, in fluid communication with an outlet 46 for the cooling water.

According to the subject apparatus and method, the charging current density can be increased greatly by reducing the gap “a” between the discharge electrode 50 and the cooled, grounded surface, leaving the rest of the ESP (i.e., with normal discharge electrode 50 to collector plate 12 spacing “b”) to operate at the same applied voltage but with current densities low enough to avoid back corona. By causing the particle charging to occur between a given discharge electrode 50 and a cooled stiffener rib 32 directly opposite the electrode 50 and extending out towards the electrode from the collector plate 12, the gap between the two is reduced. For purposes of illustration but not limitation, for precipitator plate spacings of 9 inches (22.9 cm) on-center, in one embodiment, the cooled stiffener rib 32 may extend away from the collector plate 12 at its greatest height “c” for 2 inches (5.08 cm), and along the collector plate 12 for a width “d” of 4 inches (10.16 cm). As further shown in FIG. 3, the gap “a” between the discharge electrode 50 and the outer surface 52 of the cooled structure 32 may be about 2.5 inches (6.35 cm), as compared to a spacing “b” between a downstream discharge electrode 50 and the collector plate of about 4.5 inches (11.43 cm). The inner wall 54 of the cooling structure 32 may lie adjacent to the rib 20. For wider plate spacings, these dimensions will be proportionally larger.

FIG. 4 shows, for convenience of comparison, a partial installation of another embodiment of the subject apparatus comprising a section of an ESP corona discharge system including a pair of ESP collector plates 12 having a leading edge stiffening rib/baffle 20, one of which has a cooling structure 32 installed, and an associated discharge electrode 50 intermediate to the plates. For purposes of illustration but not limitation, in one embodiment, the stiffener rib 20 may extend away from the collector plate 12 for about 2 inches (5.08 cm) on each side, and along the collector plate 12 for a width “d” of 4 inches (10.16 cm). As shown in more detail in FIG. 4A, in this embodiment, the cooling structure 32 may comprise a water chamber within 14 gage 316 Type stainless steel, and may have a width “e” of about 1.25 inches (3.175 cm) between the exterior surfaces of its outer wall 52 and inner wall 54, which inner wall 54 borders the stiffener rib 12 for about 4.47 inches (11.35 cm). In this embodiment, the inner wall may be positioned at an angle θ of about 26.6° with respect to the cooling plate 12. The cooling structure 32 may be attached to the cooling plate 12 and/or stiffener rib 20 by a braze or weld 56, and may additionally or alternatively be fastened by a fastener 60 such as but not limited to a screw or rivet to the stiffener rib 20. The stiffener rib 20 may be provided with a hole or holes 58 for accepting the fastener 60. The cooling structure may also include an inlet and outlet (not shown) for the cooling water.

The inlet for the gas flow 24 between the cooled rib structures 32 is decreased. The discharge electrode 50, which for weighted wire configurations, may be a 0.109 inch (0.28 cm) diameter wire variably disposed between them, has a narrower than conventional gap to increase the charging density between the electrode and the cooled structure relative to other discharge electrodes and the collector plate away from the cooled rib structures.

The subject collector plate assembly comprising a physically cooled surface may be incorporated integral to the existing collector plate structure of the ESP being modified. This may be done by replacing existing ESP collector plate stiffener ribs or baffles, with hollow structures, such as but not limited to tubes, in which a cooling fluid, such as but not limited to water, flows.

The stiffener ribs may be constructed and installed with a cross sectional geometry appropriate to achieve high charging current densities, while providing the needed structural plate rigidity. The installation may include the placement of one or more discharge electrode(s) in appropriately close proximity to the cooled ribs. The profile design of the integral cooled surface may be determined by the available power supply and charge density considerations, discussed in more detail below.

The subject apparatus and method may result in the production of discrete, high charging current density region(s) of up to 100 nA/cm² in gas flow passes within an ESP. The efficient collection of high resistivity particulate matter with a cooled surface collector plate structure may comprise operation at current densities that are 10 to 20 times the non-cooled surface current densities, which can be as low as 5 nA/cm². This ratio may be optimized for specific particulate or fly ash resistivity. The present apparatus and method may utilize discharge electrode-to-plate clearance(s) and/or discharge electrode diameter(s) or electrode design configurations to achieve the target current density.

In certain embodiments, the discharge electrode-to-plate clearance (or distance) may be reduced by about 55% to achieve the desired minimum current increase in the discharge electrode-to-rib region of the collector plate assembly. For conventional 9 inch (22.9 cm) discharge electrode-collector plate spacing designs, for example, this would involve opposed, 2 inch (5.1 cm) high ribs or OPZEL™ structures. For installations of up to 12 inches, on-center, dimensions and voltages may be scaled on a linear basis.

Room for a second discharge electrode per rib/cooling structure may be needed in certain embodiments. The reduced cross-sectional flow area produced by the opposing ribs/cooling structures in each gas pass increases the gas velocity, decreasing the treatment time available for charging particulate matter by about 55% over that in conventional corona discharge systems. The introduction of an additional discharge electrode in the corona discharge system would alleviate the corresponding loss in particle charging capacity. In certain embodiments, the distance between the two discharge electrodes will be about twice the discharge electrode-to-cooled rib/cooling structure distance to avoid electric-field interference in corona production between the electrodes.

Similarly, the flue gas pressure drop across the collector plates for installations that utilize multiple ribs/cooling structures in series may be minimized by conventional design considerations. For example but not for limitation, a venturi style configuration may be applied to the reduced cross sectional area in lieu of the conventional triangular OPZEL™ baffles, with a double venturi used for double electrodes.

The cooled rib/cooling structure may operate at a temperature approximately 200° F. (111° C.) below the rest of the collector plate, with the ash layer operating at approximately 180° F. (82° C.). Therefore, the rib/cooling structure may be designed and attached to the collector plate assembly in a manner that can handle the resulting differential thermal expansion. By way of example but not limitation, for 30 foot (9.14 meters) high carbon steel plates, this differential expansion at operating temperature is approximately 0.56 inches (1.42 cm) overall. Fabricating the cooling structure from austenitic stainless steel will slightly reduce the strain, due to the increased coefficient of expansion of stainless steel. The remaining differential thermal expansion between the collector plate and the cooled rib/cooling structure, may be taken up in the attachment hardware. An installation procedure that cools the rib by 100° F. (55.5° C.) with respect to the plate material during attachment will cut this strain in half. Utilizing spot welds and a rippled attachment strip will further allow differential expansion. Also, riveting through attachment slots in the plate may be done. A finite element thermal expansion analysis of the design can define the final configuration.

The liquid filled weight of the rib/cooling structure may be minimized to avoid or reduce corona discharge system structural modifications, while providing adequate cooling and uniform temperature at any given elevation of the collector plate. Weight minimization may allow installation without additional structural modifications for support. In addition, since collected particulate is removed by accelerating the structure such as by rapping, reducing the mass of the cooling structure reduces the stress in the associated attachment hardware. In one embodiment, the cooling structure will comprise a tube-in-a-tube configuration. Once the external profile of the cooling structure is established by electric-field and gas flow analysis, an internal tube with the same profile may be fabricated, producing a liquid fillable annulus, for example but not limitation of about a half inch (1.27 cm), between the inner and outer tubes or walls of the cooling structure. Spacers and/or end caps may hold them concentrically. In this manner, each cooling structure may add less than about 10% to the original collector plate mass.

Rapping forces for dust or particulate removal from the collector plate assembly may be accommodated by re-enforcement at the top attachment points of the cooled structure. The desired cross sectional area of the attachment hardware and weld can be defined by a conventional finite element analysis, considering the anticipated rapping acceleration to be experienced by the structure.

In certain embodiments, the cooling liquid inlets of all collector plates in a field may be tied together, providing uniform inlet temperatures, optionally with cooling liquid entry positioned at the bottom of the cooling structures. The cooling liquid outlets, at the top of the cooling structures, may also be tied together, although outlet temperature variation is not of particular concern. Flexible liquid attachments may be utilized as determined on a case by case basis, to be capable of withstanding anticipated rapping forces.

The discharge electrode design may be optimized for specific ash resistivity values, such that higher current density ratios are produced when treating higher resistivity ash. As noted above, this may be accomplished by adjusting the distance between the corona discharge electrode and the cooled surface of the collector plate assembly, and selecting the design of the discharge electrode associated with the non-cooled surface of the collector plate assembly, such as but not limited to wire diameter for weighted wire electrode designs and electrode shape/design for rigid discharge electrodes.

The discharge electrode design may be conveniently changed as changes in fuel produce variations in particulate, or fly ash resistivity. The highest resistivity ash may require up to an approximately 20:1 current density ratio between discharge electrodes for cooled structure surfaces versus non-cooled plate surfaces. In certain embodiments, to implement this ratio with a single voltage power supply, the distance between the cooled structure surface and the corresponding discharge electrode may be reduced to 45% of the normal discharge electrode-to-collector plate distance.

For weighted wire electrode designs, the discharge electrode associated with the cooled structure surface may be made significantly smaller in diameter, increasing current flow over wire electrodes associated with the non-cooled surfaces. In certain embodiments, wires as small as 3/32 inches (0.24 cm) diameter in the cooled positions, and as large as ¼ inch (0.64 cm) diameter for non-cooled positions, may be used to provide this bias. In some embodiments, the position of weighted wires may be at least half the collector plate spacing distance from the leading and trailing edges of the collector plates to allow sufficient clearance between plate supporting hardware, such as C-channel hardware, and the hook/sheath for the wire. For rigid discharge electrode designs, the discharge electrode in the cooled position may be more aggressive in generating an electric-field gradient than those at the non-cooled positions.

Performance considerations will determine the position and number of cooled surface corona discharge systems to be installed in a given ESP. Test results indicate the greatest collection efficiency improvement occurs with aggressive particulate charging at the upstream edge of the inlet field of an ESP. Each additional cooled surface corona discharge system operated further downstream experienced a reduction in efficiency improvement, but a combination of cooled surface corona discharge systems on inlet and downstream fields resulted in an overall efficiency gain.

Provided is a method of improving particulate collection efficiency in an electrostatic precipitator having a collector plate comprising at least one conductive sheet and ribs or stiffeners in physical and electrical contact with the at least one conductive sheet and positioned transverse to gas flow direction, comprising physically associating at least one rib or stiffener with a hollow structure adapted to contain a cooling liquid, in spaced apart relation to a corona discharge electrode in proximity to the rib or stiffener having the associated hollow structure, the discharge electrode capable of generating a current density of at least about 50 nA/cm² in the gas flow pass between the discharge electrode and the cooled hollow structure.

Three potential embodiments of a cooled surface corona discharge system (comprising a corona discharge electrode and rib/cooling structure) installation include the following:

A minimal retrofit, having the greatest economic payback, would equip the leading edge of the collector plates in the first one or two collecting fields in an ESP with a cooled surface corona discharge system comprising a corona discharge electrode associated with rib/cooling structure combinations. The rib/cooling structure would be installed by replacing the leading edge stiffener on the collector plate(s) with a rib/cooling structure.

A more aggressive installation, where a greater high resistivity particle collection efficiency improvement is desired despite a reduced economic payback, would equip the leading and trailing edges of all collector plates, except the trailing edge of the outlet collector plates, with a cooled surface corona discharge system comprising a corona discharge electrode associated with rib/cooling structure combinations. The rib/cooling structure would be installed by replacing both the leading edge stiffeners and the trailing edge stiffeners on the respective collector plates with a rib/cooling structure. It is possible that a collector plate trailing edge installation of the subject cooled surface corona discharge system would act as a pre-charger for the following collection field.

The most aggressive installation would require replacement of the original collector plates with new collector plates equipped with a cooled surface corona discharge system comprising a corona discharge electrode associated with rib/cooling structure combinations at multiple or all stiffening rib positions. The fluid inlets of the cooling structures could be fed a cooling flow of liquid from the lower stiffener of the collector plate, and the outlet liquid flows could be collected in the upper stiffener.

Installation of the subject corona discharge system apparatus has been described with respect to the retrofit of existing ESP fields. However, new ESP facility installations can be made using any one or a combination of the three embodiments described above with respect to retrofit applications.

The installation of cooled rib charging on warped ESP collector plates has the potential to restore significant performance to them. Normally, warping occurs at the center of the collector plates, with the leading and trailing edges retaining straightness. Much of the performance degradation due to warped collector plates comes from the concentration of charging current in the close clearance areas, denying other areas the appropriate collecting current density. Installing the cooled surface corona discharge system comprising a corona discharge electrode associated with rib/cooling structure combinations on the leading edge of such plates would provide charging at elevations where it was otherwise absent, at least partially restoring performance.

For retrofit or new installations, therefore, the at least one rib or stiffener with which the hollow structure is physically associated may be positioned at a leading edge of the collector plate. The at least one rib or stiffener with which the hollow structure is physically associated may be positioned at a leading edge and a trailing edge of all the collector plates in a precipitator field, except the trailing edge of the outlet collector plates of the precipitator field. The at least one rib or stiffener with which the hollow structure is physically associated may be positioned at all stiffening rib positions. The hollow structure may comprise a tube-in-a-tube configuration. The hollow structure may comprise the at least one rib or baffle, or may be in physical, thermal and/or electrical contact with the at least one rib or baffle.

### EXAMPLES

The following embodiments are for illustration only, and the scope of the apparatus and method are not intended to be limited to these specific examples.

### Material:

Corrosion resistance on both the inner diameter and the outer diameter of the cooled structure is desired. It is assumed that any cooling water may contain significant levels of chlorides (greater than 10 ppm). Chloride induced intergranular stress corrosion cracking (IGSCC) is to be avoided, due to potential rapping induced acceleration (tensile) stress. A seal welding of the liquid containing structure may be performed; the heat affected zone of austenitic stainless steel may be depleted of chromium by chromium carbide formation at grain boundaries, becoming susceptible to intergranular corrosion that leads to stress corrosion cracking.

The use of low carbon alloy, such as 308L or 317L stainless steel, reduces the susceptibility to intergranular stress corrosion cracking, as does the use of titanium stabilized Type 321 stainless steel.

Solution annealing following welding at 1900° F. to 2050° F. (1037.7° C. to 1121.1° C.) also may reduce the susceptibility to intergranular stress corrosion cracking. For thin walls, a 5 minute soak time may be sufficient, followed by fast cooling, usually with water.

### Rib or Baffle/Cooled Structure:

It is desired that the cooled structure minimizes weight, evenly distributes liquid flow, such as water flow, has the capability of a variable cooled surface height test (distance to discharge electrode), allows a double discharge electrode configuration, and accommodates an attachment configuration that will survive rapping acceleration.

It is desired that the cooled structure minimizes water weight. If a 30 foot high (9.14 m) cooling plate having three OPZEL™ baffle/cooling structures is considered, each cooling structure could easily contain 2.5 cubic feet (0.07 m³) of water, weighing about 150 lbs (68 kg) each, not accounting for the weight of the steel. The water in three of the cooling structures would add 450 lbs (204.1 kg) to the collector plate weight. Constructing the cooling plates with a tube-in-a-tube cooling structure could reduce the weight of the water by about half.

Reducing the cooling structure-to-discharge electrode distance to half the normal discharge electrode to collector electrode distance may produce a 10:1 current disparity using identical discharge electrode wire diameters.

Water flow will typically be distributed relatively evenly on both sides of the cooled rib or baffle, to avoid thermal expansion bending the collector plate.

A double cooled rib or baffle, associated with two discharge electrodes per cooled surface may have significant charging advantages, especially for ESP inlets with significant space charge effect. One embodiment may comprise a double pipe, creating a “FIG. 8” in plan view, with a discharge electrode adjacent to each close point. This embodiment may increase water weight, along with stress between the plate and the rib or baffle attachment, during rapping. Leading and trailing edge cooled rib or baffle structures could be made to attach at the top of the collector plate support, eliminating this issue. A center cooled rib or baffle structure may be hung off the collector plate at a position that produces the greatest lever arm distance from the collector plate support beams, potentially limiting allowable rapping acceleration.

### Discharge Electrode

In one embodiment, for a weighted wire design, the charging discharge electrode may be as large as 0.109 inches ( 7/64 in or 0.28 cm) diameter or smaller. The next smaller size could be 0.094 inches ( 3/32 in or 0.24 cm). Increasing the size for the field electrodes may be used to achieve up to a 20:1 ratio between the current density in the cooled structure surface area and the non-cooled collector plate area.

A discharge electrode may be brought into close proximity to each cooled rib/baffle pair. Reduction in distance between the discharge electrode and the cooled structure may create an intense current density of up to about 100 nano-amps/cm². Cooled fly ash at approximately 180° F. can support a current density of about 160 nano-amps/cm² without back corona discharge.

Originally positioned discharge electrodes may remain at existing gas pass positions to provide an electric field for ash collection. The diameter of these discharge electrode wires, or the aggressiveness of rigid discharge electrodes may be adjusted for reduced current flow.

The subject apparatus and method are thus capable of collecting high resistivity particulate, such as fly ash in the absence of SO₃. The fly ash is highly charged adjacent to the cooled structure surface, where it no longer is highly resistive. Fly ash collected on the non-cooled collector plate, where it is resistive, need only conduct little current.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. An electrostatic precipitator collector plate assembly comprising:
at least one electrically conductive sheet adapted to be electrically grounded;
a rib or baffle in physical and electrical contact with the at least one conductive sheet; and,
a hollow structure physically associated with the rib or baffle adapted to contain a cooling liquid, the hollow structure optionally comprising a tube-in-a-tube configuration.

2. The collector plate assembly of claim 1, wherein a plurality of ribs or baffles are in physical and electrical contact with the at least one conductive sheet, positioned transverse to gas flow within the electrostatic precipitator.

3. The collector plate assembly of claim 2, wherein the hollow structure is in fluid communication with a cooling liquid supply conduit and a cooling liquid outlet conduit.

4. The collector plate assembly of claim 3, wherein at least one of the cooling liquid supply conduit or the cooling liquid outlet conduit comprises a stiffener for the at least one conductive sheet.

5. The collector plate assembly of claim 1, wherein the hollow structure comprises an electrically conductive outer wall.

6. An electrostatic precipitator corona discharge system comprising:
a) a collector plate assembly comprising:
at least one electrically conductive sheet adapted to be electrically grounded;
a plurality of ribs or baffles in physical and electrical contact with the at least one conductive sheet, positioned transverse to gas flow within the electrostatic precipitator;
a hollow structure physically associated with at least one of the ribs or baffles, adapted to contain a cooling liquid, wherein the hollow structure comprises an electrically conductive outer wall and optionally a tube-in-a-tube configuration; and,
b) a discharge electrode in proximity to the at least one of the ribs or baffles having the associated hollow structure, capable of generating a current density of at least about 50 nA/cm² in the gas flow pass between the discharge electrode and the collector plate assembly.

7. The corona discharge system of claim 6, wherein the hollow structure is in fluid communication with a cooling liquid supply conduit and a cooling liquid outlet conduit.

8. The corona discharge system of claim 7, wherein at least one of the cooling liquid supply conduit or the cooling liquid outlet conduit comprises a stiffener for the at least one conductive sheet.

9. The corona discharge system of claim 7, wherein the coolant liquid supply conduit is in fluid communication with each hollow structure on the collector plate assembly.

10. The corona discharge system of claim 6, wherein the discharge electrode is at least one of a conductive wire or a shaped electrode.

11. A method of removing particulate including high resistivity particles from a gas stream comprising:
providing the corona discharge system of claim 6;
flowing the gas stream containing the particulate between a plurality of collector plates;
providing a cooling liquid to the hollow structures;
generating a corona discharge in the gas flow between the discharge electrode and the collector plate at a current density of at least about 50 nA/cm²; and,
collecting the particulate charged by the corona discharge on the collector plate.

12. The method of claim 11, further comprising flowing the cooling liquid through the hollow structures from a cooling liquid supply conduit to a cooling liquid outlet conduit.

13. A method of improving particulate collection efficiency in an electrostatic precipitator having a collector plate comprising at least one conductive sheet and ribs or stiffeners in physical and electrical contact with the at least one conductive sheet and positioned transverse to gas flow direction, comprising physically associating at least one rib or stiffener with a hollow structure adapted to contain a cooling liquid, in spaced apart relation to a corona discharge electrode in proximity to the rib or stiffener having the associated hollow structure, the discharge electrode capable of generating a current density of at least about 50 nA/cm² in the gas flow pass between the discharge electrode and the cooled hollow structure.

14. The method of claim 13, wherein the physically associated at least one rib or stiffener is positioned at a leading edge of the collector plate.

15. The method of claim 13, wherein the physically associated at least one rib or stiffener is positioned at a leading edge and a trailing edge of all the collector plates in a precipitator field, except the trailing edge of the outlet collector plates of the precipitator field.

16. The method of claim 13, wherein the physically associated at least one rib or stiffener is positioned at all stiffening rib positions.

17. The method of claim 13, wherein the hollow structure comprises a tube-in-a-tube configuration.

18. The method of claim 13, wherein said physically associating at least one rib or stiffener with a hollow structure comprises replacing the at least one rib or baffle with the hollow structure.
